(19) United States
(12) Patent Application Publication
(10) Pub. No.: US 2009/0266823 A1
(43) Pub. Date: Oct. 29, 2009

(54) METHOD FOR MANUFACTURING A SEALING BLADDER MADE OF THERMOSETTING POLYMER FOR A TANK CONTAINING A PRESSURIZED FLUID, SUCH AS A COMPOSITE TANK, AND A TANK

(75) Inventors: Philippe Mazabraud, Orleans (FR); Fabien Nony, Monts (FR); Charles Deleuze, Monts (FR); Olivier Perrier, Neuville Aux Bois (FR); Dominique Rocle, Fleury Les Aubrais (FR); Gwenael Doulin, Chartres (FR); Abbas Tcharkhtchi, L'Hay Les Roses (FR); Albert Lucas, Boulogne Billancourt (FR)

Correspondence Address: OBLON, SPIVAK, MCCLELLAND MAIER & NEUSTADT, L.L.P., 1940 DUKE STREET, ALEXANDRIA, VA, 22314, US

(73) Assignees: COMMISSARIAT A L'ENERGIE ATOMIQUE, Paris (FR); RAIGI, Rouvray Saint Denis (FR)

(21) Appl. No.: 12/304,209

(22) PCT Filed: Jun. 15, 2007
(86) PCT No.: PCT/EP2007/055971

§ 371 Date: Dec. 10, 2008

(30) Foreign Application Priority Data
Jun. 16, 2006 (FR) 06 52152

(51) Int. Cl. F17C 1/00; B28B 1/02; B29C 69/00

(52) U.S. Cl. 220/581; 264/310; 264/241

(57) ABSTRACT

A method for manufacturing a polymer bladder assuring the internal sealing of a tank vis-à-vis a pressurized fluid which is contained therein, wherein said polymer is a thermosetting polymer, and said method comprises at least one step of polymerizing at least two precursor compounds of said thermosetting polymer carried out in a mould in rotation.

A tank for storing a pressurized fluid for example a type IV tank comprising said polymer bladder.

### TECHNICAL FIELD

The present invention relates to a method for manufacturing a bladder or envelope made of polymer assuring the internal sealing of a tank vis-à-vis a pressurized fluid which is contained therein, wherein the tank is a tank such as a composite tank, for example a type IV tank.

The invention also concerns a tank such as a composite tank, for example a type IV tank comprising an envelope or sealing bladder capable of being obtained by this method.

The technical field of the invention may, as a general rule, be defined as that of the storage of fluids and in particular of pressurized gas, in other words at a pressure above atmospheric pressure with a particular interest for natural gas, compressed air, neutral or inert gases, natural gas, and especially hydrogen.

The envelopes or sealing bladders of the present invention may be used for example for the manufacture of composite tanks, for example type IV or hydraulic accumulator composite tanks.

Composite tanks are tanks in which the pressure of the fluids, particularly of the stored gases, is generally from 10⁶ to 10⁸ Pa, more precisely from 10⁷ to 10⁸ Pa (in other words 100 to 1000 bars). Their structure must therefore be provided first to be leak tight to the fluids, for example to the stored gases, and secondly to withstand the storage pressure (known as service pressure), and the filling conditions (pressure, rate of filling and number of fillings) of these fluids such as gases.

It is for this reason that these tanks comprise an internal gas sealing bladder, also known as internal envelope “liner”, and an external reinforcement structure normally consisting of carbon fibres and a thermosetting resin normally an epoxy resin.

This bladder may be metallic, for example made of aluminium or steel, or instead the bladder may be made of a polymer, generally thermoplastic.

In this latter case, the term type IV composite tank is used.

The sealing bladder is a revolving, revolution, structure, generally without welds and homogeneous, with improved properties of permeability (or barrier properties) to fluids such as gases and mechanical strength. The sealing bladder is equipped with one or two base plates at one or at two of its ends.

The polymer sealing bladder may be obtained by extrusion-blow moulding, by extrusion or by rotomoulding, and particularly by reactive rotomoulding which is the technique that will be of particular interest in the present invention. The external reinforcement structure may be obtained for example by filament winding.

The present invention particularly finds its application in the manufacture of low temperature fuel cells for example proton exchange membrane fuel cells or PEMFC.

In the following description, references between square brackets ([ ]) refer to the list of references given after the examples.

### PRIOR ART

Type IV tanks were developed in the 1990s, firstly for the on-board storage of natural gas with bladders made of polyethylene, and, more recently, essentially from 1997, for the storage of hydrogen.

The polymer bladders currently used are made of thermoplastic polymer, and are for the most part constituted of polyethylenes (PE). These polyethylenes are usually high density polyethylenes (HDPE), sometimes cross-linked (XHDPE). Other thermoplastic bladders consist of polyamide (PA) (usually known as “Nylon” (trade name)) of PA6 type, and more rarely PA12 or 11, because they have gas barrier properties intrinsically better than polyethylene.

However, their ductility is often less good than that of polyethylene and their thermo-mechanical behaviour is not always acceptable. Specific PA6 may be used in order to combine a good mechanical behaviour with good barrier performance to gases and particularly to hydrogen. Documents [1] describes such PA6.

Finally, other thermoplastics may be used because they have good barrier properties to gases, such as polyvinylidene difluoride (PVDF). Multilayer solutions with a barrier layer in ethylene-vinyl alcohol (EVOH) copolymer may also be used. Documents [3] and [4] describe such thermoplastics. However, their ductibility is often insufficient to be able to use them as components of sealing bladders of composite tanks and particularly type IV tanks.

Most of the time, these bladders are obtained by rotomoulding or extrusion and/or blow moulding of molten thermoplastic material. For instance, in document [5], it is disclosed that the thermoplastic bladder is obtained by extrusion-blow moulding or rotomoulding, preferably using high or medium density polyethylene. In document [6], sealing bladders made of polyethylene, polypropylene or polyamide are obtained by rotomoulding. In document [7], it is disclosed that the bladder in nylon 11 is formed by rotomoulding. In document [8], it is disclosed that the bladder is obtained from a thermoplastic material that is extruded, blow moulded or rotomoulded. In documents [9] and [10], it is disclosed that the thermoplastic bladder may be moulded by extrusion, blow moulding or by rotomoulding.

Document [11] describes a method intended to manufacture by rotomoulding or by extrusion-blow moulding a weld-free thermoplastic bladder of a pressurized composite tank having an internal heat exchanger.

Document [12] describes a method for manufacturing a pressurized tank, method wherein is introduced, into a mould inerted by a neutral gas, a monomer which is then polymerised at a high temperature in the mould in rotation.

In document [13], a method for manufacturing a pressurized tank is described: it involves a method in which the “liner” is a thermoplastic polymer obtained by rotomoulding.

Document [14] describes a method for manufacturing a thin thermoplastic bladder of a composite high pressure tank.

All the documents (patents and patent applications) cited above only describe methods in which the sealing bladder is formed of a thermoplastic polymer.

In documents [15] and [16] a method for manufacturing a composite tank for the storage of pressurized natural gas is mentioned, the “liner” of said tank may be obtained from liquid precursors, namely: “Teflon” (trade name), an isocyanate, a urethane or a silicone. However, these precursors are added to the interior of the composite shell formed beforehand and play the role of a thin deposit or coating and not of a generally self-supporting sealing bladder in the sense of the invention.

Documents [17] and [18] describe a method for manufacturing autonomous pressurized tanks for compressed air, the flexible sealing bladder of which may be made of polyurethane. The shape of the bladder used by this method is constituted of several cells and the architecture of the tank obtained is different to that of a tank in the sense of the invention. Moreover, this tubular concept does not enable the tank to be used at high pressures.

Documents [19] and [20] also describe a method for manufacturing autonomous pressurized tanks for compressed air and cite possible applications for the storage of helium, nitrogen or hydrogen for example. The internal sealing bladder may be made of polyethylene or polyamide. This bladder is obtained by injection, by extrusion-blow moulding or by rotomoulding. The internal sealing bladder may also be made of a thermoplastic polyurethane of trade name “Pellethane” (supplier: DOW) or trade name “Texin” (supplier: Bayer Plastics Division).

The use of a thermosetting polymer is neither described nor suggested in these documents [19] and [20].

The method for manufacturing the bladder made of thermoplastic polyurethane is moreover not mentioned. The shape of the bladder used by this method is generally different to that of the present invention since it comprises at least two interconnected channels. The architecture of the tank obtained is different to that of the tank (particularly type IV) of the present invention

The normal type IV tanks described for example in document [21] for the storage of gases, particularly natural gas and hydrogen at service pressures from 350 to 700 bars, particularly, all use internal bladders made of thermoplastic polymer.

Documents [22] to [28] describe the state of the art, the developments underway and especially what thermoplastics are used for the manufacture of sealing bladders in type IV tanks, with a view to an application in fuel cells. But, none of these documents either mentions or suggests elements, or sealing bladders (“liners”) made of thermosetting polymer or their manufacture.

An important parameter of the specification set for the on-board storage of hydrogen for fuel cell vehicles (see table 1) is the tank refuelling rate.

TABLE 1
American DOE specification for the on-board storage
of hydrogen (application to fuel cell vehicles)

| | Parameter | | |
|---|---|---|---|
| | 2005 | 2010 | 2015 |
| Usable specific energy | 1.5 | 2.2 | 3 |
| (kWh/kg) | | | |
| Useable energy density | 1.2 | 1.5 | 2.7 |
| (kWh/L) | | | |
| Cost | $6 | $4 | $2 |
| ($/kWh) | | | |
| Lifetime in number of fillings | 500 | 1000 | 1500 |
| (¼ of the tank to full) | | | |
| Refuelling rate (kg H₂/min) | 0.5 | 1.5 | 2 |
| Permissible hydrogen loss | 1 | 0.1 | 0.05 |
| (grammes) | | | |

Documents [30] to [35] describe the effects of the rapid filling with hydrogen gas on the temperature of the sealing bladders of composite tanks, the pressure of which is 350 (35 MPa; 5000 Psi) and 700 bars (70 MPa; 10000 Psi). Given the shape and the volume of the tank and the filling procedure (temperature of the gas at the inlet of the tank, filling speed and flow rate, etc.), the temperature of the gas in contact with the internal surface of the bladder may be more or less high and is generally situated between 50 and 150° C. Sometimes, this temperature is sufficiently high to lead to the local melting of the thermoplastic polymer, which can lead to an increase in the leakage rate of the tank and/or the mechanical bursting, failure, of the bladder.

The current technology of rotomoulding of molten thermoplastic materials is of particular interest. Indeed, it makes it possible:
to be able to manufacture hollow parts of large dimension, going up to 150 litres, or even beyond;
to be able to insert one or several base plate(s) (in other words connection mouthpieces that make it possible to fill the bladder with gas and empty it), and to do this, without bonding subsequent to the implementation; and
to provide thick homogeneous sealing bladders and without residual mechanical stresses.

In all of these methods, the thermoplastic material is melted in order to be shaped to the desired geometry of the bladder, then must be cooled before being removed from the mould. Numerous defects of the bladder result from this melting, particularly the formation of “reticulas”, unmelted materials, microporosities, and oxidations of the thermoplastic material. These defaults adversely affect the final sealing performance and/or mechanical strength of the bladder, and therefore the performance of the tank. Moreover, in the case of rotomoulding, even though the subsequent bonding of the base plate to the bladder is not necessary, the sealing between the base plate and the bladder is not always satisfactory, on account of the fluidity of the molten thermoplastic material which is insufficient to intimately hug the shapes of the base plate. Moreover, this fluidity of the molten material cannot be increased by raising the temperature without causing a chemical alteration of said material. Furthermore, the most widely used method of rotomoulding takes a lot of time, further extended by the cooling time of the material after moulding of the bladder, due particularly to the inertia of the mould and/or the part.

Polyamide 6 (PA6), is the thermoplastic that appears the most interesting for the manufacture of sealing bladders, given the compromise between its barrier properties to gases, particularly hydrogen, and its mechanical properties over a wide range of temperatures ranging from −40° C. to +100° C. Unfortunately, in the techniques of the prior art, PA6 is always poorly adapted to rotomoulding which, like other thermoplastic material moulding technologies, requires the material in powder form to be melted to give it the desired shape then to cool it. This melting leads to the defects identified above, which adversely affect the final performance of the tank.

The development of thermoplastics, for example PA6, of grades more suited to rotomoulding, in terms of the water content of the powders, viscosity, molecular weight, with addition of anti-oxidants, etc. does not enable these defects to be resolved.

Moreover, the evolution of the technology of rotomoulding machines, with improvements such as for example rotomoulding under nitrogen, controlled cooling, reduction in the cycle time, do not enable these defects to be resolved either.

Indeed, for example, the melting of PA6 begins from around 200° C., and this melting step causes a chemical degradation because the PA6 has to remain for 5 to 15 minutes at process temperatures sometimes exceeding its melting temperature by 40° C.

Recently, reactive rotomoulding technology, described particularly in document FR-A-2 871 091, has made it possible to manufacture bladders (“liners”) in polyamide 6 at lower process temperatures (around 170° C.) than with conventional rotomoulding by molten route (around 260° C.). But the cycle times remain significantly longer than in the present invention. Moreover, whatever the rotomoulding method used, the thermoplastic bladders (“liners”) that are exclusively mentioned in this document have lower maximum temperatures of use than in the context of the present invention, given the chemical nature of the polymer (thermoplastic and not thermosetting).

Moreover because of the thermoplastic nature of the sealing polymer bladders that they use, pressurized tanks in particular type IV tanks of the prior art do not make it possible to meet the requirements of rapid filling with gases, particularly natural gas and hydrogen, because the physical phenomena brought about by this rapid filling lead to a rise in the temperature of the gas which can bring about a physical-chemical modification or even a partial melting of the bladder in contact with this gas.

No method of the prior art provides a satisfactory solution to the numerous abovementioned problems.

There therefore exists a need for a method for preparing a polymer bladder intended to assure the sealing of a tank vis-à-vis a pressurized fluid which is contained therein, which makes it possible to obtain a sealing bladder for a tank, in particular a type IV tank, which does not have the abovementioned defects. This bladder must particularly be able to withstand higher temperatures, in particular during filling.

This method moreover must lead to a reduced manufacturing time.

This method must particularly enable the manufacture of a tank bladder for low temperature fuel cells (PEMFC), where the storage of hydrogen carried out under pressures ranging from 350×10⁵ Pa to 700×10⁵ Pa, or even 1000×10⁵ Pa, requires light, reliable and inexpensive tanks, particularly for storage in transport means.

The aim of the invention is to provide such a method for preparing a polymer bladder that meets all of the needs and requirements listed above.

A further aim of the invention is to provide a method for preparing a polymer bladder intended to assure the sealing of a tank vis-à-vis a pressurized fluid which is contained therein, which does not have the drawbacks, failings, limitations and disadvantages of the methods of the prior art and which resolves the problems of the prior art.

### DESCRIPTION OF THE INVENTION

This aim and yet others are attained according to the invention by a method for manufacturing a polymer bladder providing, assuring the internal sealing of a tank vis-à-vis a pressurized fluid which is contained therein, wherein said fluid is under a pressure of at least 50 bars, preferably at least 200 bars, even more preferably at least 350 bars, most preferably at least 700 bars; wherein said polymer is a thermosetting polymer, and said method comprises at least one step of polymerising at least two precursor compounds of said thermosetting polymer carried out in a mould in rotation.

Generally the sealing bladder is self-supporting.

Generally the bladder is of cylindrical shape with hemispheric bottoms.

In a fundamental manner according to the invention, the polymer used to manufacture the sealing bladder is a thermosetting polymer and not a thermoplastic polymer.

The use of a thermosetting polymer to prepare such bladders is neither described nor suggested in the prior art.

The method of the present invention does not lead to a thermoplastic bladder as in the prior art, but to a thermosetting bladder by starting with precursors of said thermosetting polymer, the polymerisation of which in the mould in rotation is initiated, primed, starts at a temperature lower than the temperatures of use of thermoplastic polymers, namely a temperature generally from 10 to 100° C. for example of 40° C. instead of a temperature greater than 150° C. for the thermoplastic polymers used in the prior art.

The bladder of the present invention made out of thermosetting polymer, prepared by polymerisation at lower temperatures, may conversely be used at higher maximum temperatures than the bladders of the prior art for example from 120 to 150° C. instead of from 60 to 90° C.

The bladder according to the invention is manufactured more quickly than bladders of the prior art made of thermoplastic polymer, for example in a time of 4 to 8 minutes instead of 15 to 60 minutes.

The tank in which the internal sealing is assured by the bladder made of thermosetting polymer, for example made of polyurethane prepared by the method according to the invention, may be particularly a composite tank, in particular a tank known as type IV.

The term “composite tank or type IV tank” is well known to those skilled in the art in the field of pressurized fluid tanks.

The pressurized fluid contained in the tank is preferably a gas, or a mixture of a gas and a liquid, for example a mixture of nitrogen and mineral oil.

More precisely, the method for manufacturing a polymer bladder according to the invention may comprise the following successive steps:
(a) preparation of a polymerisation mixture comprising the precursor compounds of the thermosetting polymer, and optionally at least one polymerisation catalyst;
(b) polymerisation of said mixture to obtain said thermosetting polymer, in a mould in rotation, so as to form said bladder by polymerisation of said precursors and simultaneous rotomoulding of the thermosetting polymer;
(b1) if necessary repetition of steps (a) and (b) so as to obtain a bladder with several layers of thermosetting polymer; and
(c) removal from the mould of the thermosetting polymer bladder obtained.

In the present invention, the thermosetting polymer is manufactured and moulded in a single step in a mould, generally at a not very high temperature for example from 10° C. to 100° C.

In the method according to the invention, the polymer is formed at the same time as it hugs the shape of the mould and it does this generally in a very short time. The term reactive rotomoulding is used since the rotomoulding mould serves both as chemical reactor and as mould giving the shape of the actual bladder.

Unlike the methods of the prior art where the bladders are made of thermoplastic polymer, the method according to the invention makes it possible to obtain tanks, particularly type IV tanks, by reactive rotomoulding at a low working temperature for example from 10 to 100° C. and in a short time for example from 4 to 8 minutes of cycle time for a single layer bladder.

The polymerisation reaction of the precursors for example polyol(s) and isocyanate(s) used in the present invention is an absolutely conventional chemical reaction, which makes it possible to polymerise precursors of a thermosetting polymer for example a polyurethane in said thermosetting polymer. Those skilled in the art in the field of macromolecular chemistry will have no difficulty in implementing this polymerisation reaction. The only restrictions are those indicated in the definition of the method of the invention, in other words those linked to the specificities of the polymer bladders of tanks containing a pressurized fluid for example of type IV gas tanks.

In particular, it is preferable that the bladder obtained is leak tight to the fluid such as a gas that will be stored therein, even at the pressures indicated above, is sufficiently flexible to follow the deformations of the composite shell under the effects of pressure, but is sufficiently stiff to withstand the implementation of the composite external reinforcement, and has a sufficiently high operating temperature to withstand the rapid filling of the tank.

According to the invention, the precursor compounds of the thermosetting polymer used are preferably precursor monomers of the thermosetting polymer used for the manufacture of the bladders.

According to the invention, preferably, the thermosetting polymer is a polyurethane, and the precursors comprise at least one polyol and at least one isocyanate, wherein the polymerisation of the precursors is a polymerisation by polyaddition.

The polyol(s) may be chosen among polyether polyols such as polyoxypropylene glycols, polyoxyethylene glycols, polytetraoxymethylene glycols and aminated polyols; among polyester polyols such as glycol polyadipates and polycaprolactones; among polycarbonate diols; among hydroxylated polymers such as hydroxylated polybutadienes; among polyols of natural origin such as castor oils; or among all molecules in which the molecular chain has reactive free hydroxyl groups.

The isocyanates may be chosen among mono-, diisocyanates and polyisocyanates such as diphenylmethane diisocyanate (MDI) and its isomers, toluene diisocyanate (TDI) and its isomers, isophorone diisocyanate (IPDI), hexamethylene diisocyanate (HMDI), dicyclohexylmethane diisocyanate (H12MDI) and all molecules in which the molecular chain has isocyanate groups.

According to the invention, the polymerisation of the precursors is preferably carried out in the presence of at least one catalyst. Their role in the polymerisation of organic precursors, such as isocyanates and polyols in the case of polyurethanes, is well known to those skilled in the art and do not need to be further described herein.

As examples of catalysts may be cited aminated catalysts and metal catalysts for example based on tin or bismuth.

According to the invention, the step consisting of polymerising the monomer in the mould in rotation or rotomould in order to form the bladder made of thermosetting polymer is advantageously carried out from a polymerisation mixture comprising compounds, precursors of the thermosetting polymer, and optionally at least one polymerisation catalyst and optionally at least one polymerisation additive.

According to the invention, the polymerisation mixture may be prepared advantageously from several “pre”-mixtures, for example from 2 to 3 premixtures, each of these premixtures containing preferably at least one precursor of the polymer.

Thus, the two or more premixtures may be prepared and stored separately several weeks, or even several months before the manufacture of the bladder and mixed together at the moment of the implementation of the present invention.

The method of the present invention may also be implemented from a single mixture comprising all of the precursors and any other optional constituents, the polymerisation catalyst being added at the moment of the implementation of the method of the present invention. The mixture may also be prepared totally extemporaneously before being introduced into the mould. Those skilled in the art will easily know how to adapt the implementation of the method of the present invention according to what appears to them to be the most practical.

Examples of preparation of the polymerisation mixture are described below.

The mixing of the precursors used may be carried out at room temperature, for example for polyether polyols, and up to around 100° C., for example for glycol polyols polyadipate, solid at room temperature. The same is true for the catalyst, as well as for any other material added to the polymerisation mixture.

According to the invention, the polymerisation mixture may further comprise one or several fillers and/or nanofillers.

The fillers or nanofillers (as a function of the size and/or the shape factor of the particles of which they are composed) advantageously make it possible to improve the properties of the material forming the bladder and particularly to increase the stiffness and/or the barrier properties and/or to improve the thermo-mechanical properties and/or to reduce the permeation and/or to colour and/or to reduce the cost of the manufactured bladder. The fillers or nanofillers can also make it possible to improve the storability of the premixtures and/or the processability of the mixture of precursors.

According to the invention, the fillers and/or nanofillers may be chosen for example among clay flakes, foils, carbon blacks, carbon nanotubes, silicas, carbonates, kaolins, dolomites and other mineral fillers, pigments, zeolites, organic fillers, and any other fillers or nanofillers having the same function.

For example, exfoliated clay flakes, foils, make it possible to improve the heat resistance of the bladder, particularly to heating during the rapid filling of the bladder with gas, for example with hydrogen. Due to the fact that the bladder prepared by the method according to the invention is made of a thermosetting polymer, it already has an excellent heat resistance, significantly better than that of bladders made of thermoplastic polymers and consequently the exfoliated clay flakes may be used in minimal quantities or even omitted. Whatever the filler or nanofiller, it may be generally added to the polymerisation mixture in a quantity ranging from 0 to 40% by weight compared to the total weight of the polymerisation mixture introduced into the mould.

The polymerisation mixture may further comprise one or several additives.

The additives advantageously make it possible to improve the conditions of use of the precursors and the polymer and to improve the properties of the material forming the bladder and particularly to increase the stiffness and/or the barrier properties, and/or to improve the thermo-mechanical properties, and/or to reduce the permeation, and/or to colour and/or to reduce the cost of the manufactured bladder.

The additives may also make it possible to improve the storability of the premixtures and/or the processability of the mixture of precursors.

According to the invention, the additives may be chosen among antioxidants (for example of phenolic or phenolic/phosphite type), stabilisers (for example of benzotriazole or HALS type), plastifiers (for example of phosphate type, phthalate type, etc.), wetting agents (for example of polysiloxane type), debubblizing agents (antifoam) (for example of silicone type), colorants, fire retarding agents (for example of phospho-halogenated type) and liquid solvents.

This or these additives are generally added to the polymerisation mixture in a quantity ranging from 0 to 20% by weight compared to the total weight of the reaction mixture.

The polymerisation mixture may also moreover comprise a chain modifier generally chosen among aromatic amine, diol and triol compounds.

In the case where premixtures are used, for example two premixtures and where the polymer is a polyurethane, one of the two premixtures (A) may contain one or several polyol(s), optionally one (or several) catalyst(s), one or several filler(s) and one (or several) additive(s) or instead may contain one or several polyols and optionally one or several chain modifiers; and the other premixture (B) may contain one or several isocyanates and optionally additives.

The premixture (B) may contain for example a prepolymer with isocyanate terminations obtained for example by reaction of MDI and polyoxypropylene glycol.

The premixtures may be heated or not, in the case of the A (based on polyol(s)) and B (isocyanate) premixtures described above, they are not, preferably, heated.

The quantity of polymerisation mixture introduced into the mould determines, as a function of the size of the mould, the thickness of the wall of the bladder manufactured by the method of the present invention.

The choice of this thickness of the wall of the bladder is made principally as a function of:
the desired barrier performance to the stored gas, for example to hydrogen, of the thermosetting polymer, for example polyurethane, (for hydrogen, ISO TC 197 and EIHP II draft standards which allow a leakage of 1 cm³/litre of tank/hour);
the mechanical performances of the thermosetting polymer, particularly of sufficient stiffness for putting in place a mechanical reinforcement external to the envelope, bladder, for example by winding of carbon fibres (the bladder then acting as mandrel), during the manufacture of the tank; and
other mechanical performances of the thermosetting polymer, for example: sufficient ductility, so as not to show fatigue during the numerous fillings of the tank (up to 15000 cycles) at a temperature between −40° C. and 85° C. and good resistance to filling temperatures up to 150° C.

The determination of the thickness of the wall of the bladder is therefore decided particularly according to the volume of the manufactured tank, the length/diameter ratio of the tank (and therefore the developed, extended surface area), the acceptable mechanical stresses and deformations, the service (operating), proof and bursting pressures of the manufactured tank, and the permeation coefficient of the polymer.

According to the invention, the bladder generally has one wall of defined thickness to withstand the leakage of the fluid, particularly of the gas, at the pressure at which it has to be stored, known as service pressure as defined above, and normally between 2×10⁷ and 10⁸ Pa, preferably between 5.10⁷ and 8.10⁷ Pa.

The present invention obviously applies to pressures other than these, generally for example from 10⁵ to 10⁸ Pa, wherein the thickness of the bladder is chosen particularly as a function of this service pressure and the nature of the fluid, for example the gas.

In general, the thickness of the bladder is from 1 mm to 100 mm, preferably from 2 mm to 20 mm, even more preferably from 3 to 10 mm.

In the method of the invention, the polymerisation is carried out in a mould in rotation or rotomould. To do this, a conventional rotomoulding machine may be used, for example such as those described in the abovementioned documents relative to the rotomoulding of a molten thermoplastic material. The “Internet” site of the Association Francophone de Rotomoulage (French-speaking Rotomoulding Association) also describes such rotomoulding machines [36]. Preferably the mould of the rotomoulding machine is sufficiently leak tight to liquids, in particular to the polymerisation mixture according to the invention.

According to the invention, the polymerisation is initiated, primed at a temperature that may be qualified as relatively low, namely from 10 to 100° C., for example 40° C., this is one of the advantages of the method according to the invention that the polymerisation starts at a not very high temperature, so as to form said bladder by polymerisation of said precursors coupled to a rotomoulding and without melting of the polymer obtained. Thus, the mould being rotated, the polymerisation leads to a formation of the thermosetting material over the whole internal surface of the mould, without any melting of said thermosetting material.

Prior to step (b) before introduction in the mould, the temperature of the polymerisation mixture may be regulated, adjusted to a value of 10 to 100° C. for example of 25° C., for example by heating.

Thus the polymerisation will be triggered from the start of the mixing and potentially before or from the introduction of the mixture into the rotomould.

For the same reasons, according to the invention, preferably, the temperature of the mould in rotation or rotomould is regulated, controlled for example by heating, totally or partially, to a value of 10 to 120° C. for example 40° C., prior to polymerisation step b) and before introduction of said polymerisation mixture in the mould.

Once again, one of the numerous advantages of the present invention is that the polymerisation temperature and a fortiori manufacturing temperature of the bladder is low.

The thermal regulation may be carried out by total or partial heating of the mould.

The heating of the mould may be carried out for example by means of an oven in which the mould is introduced. An oven can optionally be done away with, omitted, by using a mould with direct heating, for example by infrared (IR) lamps, electrical resistances, a double-walled mould with circulation of a heat conveying fluid, or a heating by induction.

It is in certain cases possible not to heat the mould and for example not to use an oven during the polymerisation itself, given the thermal inertia of the mould and the rapidity of the polymerisation reaction, and on account of the fact that it is exothermic as is particularly the case of the reaction of polyols and isocyanates leading to polyurethanes.

The mould in rotation or rotomould may advantageously be equipped with one to several vent holes and one or several inlet(s) for a neutral gas when the polymerisation reaction which is carried out, implemented, has to take place under neutral (inert) gas. In this case, the mould is then purged by an inert and optionally dry gas during the implementation of the polymerisation step b). The neutral, inert gas may for example be nitrogen or any other neutral gas known to those skilled in the art. It should be noted that the use of a neutral, inert gas is not an indispensable condition for the method of the present invention.

Those skilled in the art will easily know how to adapt the implementation of the method of the invention in order that the polymerisation of the precursors leads to the manufacture of the desired bladder.

The mould in rotation or rotomould generally has the shape of a hollow revolving, revolution, part.

The mould preferably has a substantially cylindrical shape with circular, elliptical or other base and the length/diameter ratio of said cylinder is generally from 1 to 50, normally from 2 to 10.

According to the invention, the mould is rotated along two axes (biaxial rotation) namely a primary axis and a secondary axis, so that the distribution of said polymerisation mixture, of the precursors, takes place over the whole internal surface of the mould provided to form the bladder, the envelope and in conformity with this surface.

In rotomoulding of thermoplastic material according to the prior art, the primary axis and the secondary axis speeds of rotation are between 1 and 30 rpm (“rpm”: revolutions per minute), most usually between 2 and 10 rpm. In the method of the present invention, the rotation rates are in the same range.

The gelling time and the polymerisation time obviously depend on the nature and/or the quantity of the precursors such as polyols and isocyanates, as well as the possible presence and the nature of catalysts and any fillers and/or additives but also the implementation temperatures (material and mould) and the nature and the thickness of the mould.

One of the numerous advantages of the present invention is that the polymerisation times may be very rapid. Generally speaking, it may be estimated that the polymerisation reaction and a fortiori the manufacture of the bladder are terminated in several minutes, often from 4 to 8 minutes for a single layer bladder.

For example, when the precursors used are a polyether type polyol and an MDI type isocyanate, the polymerisation is terminated after several minutes, in general from 2 to 15 minutes, often around 4 to 8 minutes.

When the polymerisation (the polymerisations in the case of several layers) is sufficiently advanced, if necessary the heating is stopped and/or the mould in rotation is taken out of the oven; the rotation of the mould is stopped, and the mould is opened. The mould may be cooled if necessary for several minutes, particularly to facilitate the handling of the part and accelerate the hardening of the part (to cool to a temperature below the Tg, the glass transition temperature). The bladder is then removed from the mould.

However, according to the invention, it is no longer necessary to cool the mould for a long period before the removal from the mould of the part, given the fact that the working temperature is generally less than or equal to 100° C. This results in evident time and cost savings compared to the methods of the prior art, particularly given the inertia of the mould, where the rotomoulding temperature was much higher than that used in the method of the present invention, and where it was necessary to wait for the material to pass from the molten state to the solid state.

According to a particular embodiment of the present invention, several polymerisation steps may be carried out successively to form a sealing bladder with several layers of thermosetting polymer. In other words, the cycle of steps (a) and (b) is repeated to form a sealing bladder with several layers of polymers.

This cycle may be repeated from 1 to several times depending on the need, for example from 1 to 5 times.

These layers may be identical or different, in thickness and/or in composition.

For instance, it is possible from the same composition of polymerisation mixture, or from different compositions to carry out several successive polymerisations and obtain a multilayer envelope, bladder according to the invention. The compositions may be different by the concentration of each of the components and/or by the nature of the components of the composition, in the scope of the definition of the polymerisation mixture used according to the invention. The polymerisation mixtures just need to be introduced successively in the mould, advantageously just before the completion of each polymerisation step.

For example, to obtain envelope wall thicknesses greater than 6 mm, advantageously, several successive polymerisation steps may be carried out until the desired thickness is attained. For example, it is easy to make a polyurethane thickness of 10 mm per layer, but a wall thickness of 5 mm is preferable. Thus, for an envelope wall thickness of 10 mm, it is preferable to make for example two successive layers of 5 mm or 3 layers of 3.3 mm.

For example when the innermost layer of the bladder, in other words that which will be in contact with the fluid, such as a pressurized gas, during its storage in the composite tank for example the manufactured type IV tank, must have particular properties in relation to the said stored gas the final polymerisation step may advantageously be carried out by means of a thermosetting polymer having said particular properties in relation to said stored gas.

For example when the outermost layer of the bladder, in other words that which would be in contact with the external reinforcement structure of a manufactured type IV tank, must have particular properties in relation to said reinforcement structure, the first polymerisation step may advantageously be carried out by means of a thermosetting polymer having these particular properties with regard to said reinforcement structure. For example, it may involve an external layer formed with a polyurethane of lower T_{g}.

Advantageously, since the polymerisation reaction of the thermosetting polymers carried out according to the invention is exothermic, it is not always necessary to heat again the mould to polymerise each layer, once the polymerisation of the first layer has started. Indeed, the polymerisation of one layer may suffice to maintain sufficient temperature for the polymerisation of the following layer.

This is especially true if the polymerisation is, according to the invention, initiated, started at a low, not very high temperature requiring little heat input. As a consequence, advantageously, it is possible to begin step (a) of a cycle before step (b) of the previous cycle has ended.

According to the invention, the bladder, envelope, obtained may moreover be subjected to one or several post-treatment(s) intended to coat its internal or external surface with one or several thin film(s) in order to further improve the sealing properties of the bladder to the fluid, such as a gas, that will be stored therein (barrier properties) and/or to confer on it particular chemical properties, for example resistance to chemical attacks, a food contact grade property or enhanced ageing resistance. This post-treatment may consist for example in a deposition (coating) treatment with a SiOₓ type layer, where 0≦x≦2, or instead Si_{y}N_{z}Cₜ, where 1≦y≦3, 0.2≦z≦4 and 0≦t≦3, by plasma enhanced chemical vapour deposition (PECVD).

This post-treatment may consist for example in depositing aluminium by physical vapour deposition (PVD), or in depositing an epoxy type compound by chemical cross-linking, or in a fluorination with fluorocarbon precursors such as CF₄ or C₄F₈, for example. Documents [37] to [40] describe this type of post-treatment well known to those skilled in the art in the manufacture of bladders particularly of type IV tank bladders, and which can be used on the bladder obtained by the method of the present invention.

According to the invention, the bladder may be subjected to a post-curing intended to attain the final characteristics of the material more rapidly. In the present invention, this post-curing will optionally be carried out subsequently during the implementation of the external composite structure.

The present invention therefore makes it possible to manufacture sealing bladders made of thermosetting polymer for example made of polyurethane, capable of entering in the manufacture of any composite tank intended for storage and in particular the storage of pressurized gas. The sealing bladders, envelopes, manufactured by the method of the invention have a better performance in terms of thermo-mechanical properties than those of the prior art.

The thermosetting polymers used according to the invention have no melting temperature and furthermore there are no longer chain breakage effects, oxidation, cross-linking, polycondensation, final porosity, residual stresses or non-homogeneity, etc., inherent in the melting and solidification phenomena of thermoplastic polymers during their processing by rotomoulding.

These improved properties obviously have an effect on all of the properties of the tanks that are manufactured from these bladders.

According to the invention, at least one tank base plate may be fixed inside the rotomould before carrying out step (b) so that the tank base plate is incorporated within the sealing envelope, bladder, during the polymerisation. When the manufactured envelope is small (for example for a small tank) a single base plate may be sufficient. For a large sized envelope (for example for a large sized tank), it is preferable to place two base plates, particularly to enable a rapid filling and emptying of the tank. The base plate(s) may be placed at one end (at the two ends) of the envelope, in particular when it has an extended, elongated shape, but it is also possible to place one or several among these base plates over the length of the liner, somewhere between the ends.

According to the invention, said at least one metal base plate assures the connection between the interior and the exterior of the tank for its filling and for the use of the stored fluid, for example of the gas. The base plate may be a base plate conventionally used for this type of tank, for example a base plate made of aluminium or steel. It may also be a base plate made of polymer, ceramic or composite material. One or several base plate(s) may be arranged in the mould to obtain one or several base plates on the manufactured envelope. The base plate(s) may be subjected to a treatment intended to further improve the sealing of the base plate/liner junction. This treatment may be for example a treatment such as that described in document [6].

The inclusion of one or several base plate(s) on the envelope may be carried out according to conventional methods known to those skilled in the art, for example according to the methods described in documents [6] and [41], or in one of the abovementioned documents where at least one base plate is provided for. In the present invention, to be joined to the base plate, the thermosetting polymer is formed by polymerisation of the precursors both in the mould and on the base plate(s), pretreated or not, positioned in the mould before the rotomoulding according to the method of the present invention. The base plate(s) may be positioned for example in the manner described in document [41].

The envelope (also known as “bladder” or “liner”) obtained according to the method of the invention, provided with the base plate(s), is then removed from the mould. Thanks to the method of the present invention, the risk of leakage at the level of the base plates is considerably reduced, because during the rotomoulding, the viscosity of the precursors at the start of polymerisation is very low and it diffuses very easily into the interstices and/or catch points of the base plate.

The present invention also relates to a tank for storing a fluid such as a pressurized gas, said tank comprising an envelope or sealing bladder capable of being obtained by the method according to the invention.

The fluid may be as defined above, it may be for example a pressurized gas.

Said pressurized gas may be chosen among hydrogen, inert gases (also known as “neutral gases” such as helium and argon, natural gas, air, nitrogen, hydrocarbons such as methane, and mixtures thereof such as argonite (mixture of argon and nitrogen) and hytane (mixture of hydrogen and methane).

Said tank is generally a composite tank.

For example, said composite tank may comprise in this order, from the interior of the tank towards its exterior, at least:
said internal sealing envelope or bladder (2),
at least one base plate (4) for example metallic, and
a mechanical reinforcement (6) external to the envelope.

The internal envelope may be as defined above. In this type of tank, it is usually known as a “bladder” or “liner”.

The base plate or base plates may be as defined above. If there are several base plates, they may be identical or different.

According to the invention, the external mechanical reinforcement of the envelope assures the mechanical strength of the tank. It may be any of the reinforcements known to those skilled in the art normally arranged around tank envelopes, for example of type III or IV. It may be for example a filament winding. This filament winding may consist for example of carbon fibres and thermoplastic or thermosetting resin, advantageously. For example, carbon fibres impregnated beforehand with non cross-linked epoxy resin may be wound around the envelope maintained by the base plate(s), for example according to one of the methods described in documents [6], [7], [42] or [43]. The envelope, which in the particular example of a type IV tank is a self-supporting structure, serves in fact as mandrel to this filament winding. A type IV tank may thereby be obtained.

The envelope manufactured according to the invention with a thermosetting polymer therefore makes it possible to obtain a type IV composite tank, the mechanical and barrier performances of which are considerably better than that of a same tank in which the bladder consists of a thermoplastic polymer and is manufactured by extrusion-blow moulding, thermoforming, injection or “conventional” or “reactive” rotomoulding.

The present invention is particularly suited to the manufacture of tanks supplying fuel cells, in particular at low temperature.

The fact of using compressed hydrogen tanks for the PEMFC, particularly for applications such as transport means (for example cars, buses, etc.) requires having sufficient autonomies, in other words to take on board as much hydrogen as possible, which is done by increasing the service pressure of the tank up to 7×10⁷ Pa (700 bars) and even more. Moreover, for transport applications, the tanks must preferably be light, which implies the use of type III or even better type IV composite tanks.

Thanks to the method of the present invention, the envelope may have a thickness such that it withstands a service pressure of the tank, as defined above, and generally between 10⁷ and 10⁸ Pa (between 100 and 1000 bars), preferably from 5.10⁷ to 8.10⁷ Pa. The composition of the present invention may therefore be advantageously used for the manufacture of a type IV tank, for example as mentioned above.

The method for manufacturing the envelope which implements a thermosetting polymer such as a polyurethane also makes it possible to manufacture a sealing envelope that can be used for the manufacture of hydraulic or hydropneumatic accumulators. Such an envelope indeed advantageously withstands the variable pressures that may range for example from atmospheric pressure (10⁵ Pa) to 10⁸ Pa and at filling temperatures from 100 to 180° C.

In a more general manner, the composition of the present invention and the implementation method by rotomoulding may be used for different applications such as:
composite tank sealing bladder (“liner”);
type IV tank sealing bladder (“liner”);
insufficiently leak tight type IV tank internal bladder coating (contribution of the gas barrier property);
type III tank internal metallic bladder coating, for example made of aluminium or steel (contribution of the gas barrier property to limit the effects of embrittlement and/or stress or water corrosion to limit the effects of corrosion);
type I or type II, internal tank coating, etc.

Thus, the specific formulation of the compositions implemented by rotational moulding in the method of the invention that lead to thermosetting polymers such as polyurethanes may be used each time that a barrier property is sought (liquid or gas or liquid+gas mixture) with optionally a good mechanical flexibility (elastic deformation without fatigue) and with optionally a thermo-mechanical resistance over a wide temperature range, typically from −60 to +150° C. for example from −40° C. to +130° C., without alteration of the above properties.

The reactive rotomoulding used in the present invention makes it possible to produce a finished product rapidly (several minutes), in a limited number of steps. The step of rotomoulding is thereby facilitated and the energy cost is reduced thanks to temperatures lower than those used in the methods of the prior art. The environment is less critical than in the prior art since an inert and/or dry atmosphere is no longer required. Industrialization is therefore easier.

Moreover, the thermosetting polymer such as the final polyurethane synthesised in situ has improved properties in terms of thermo-mechanical resistance particularly as it may be seen through the examples below. Finally, it is very easy to modify the final properties of the polymer by the choice of the nature and/or the quantity of the precursors such as isocyanates and polyols, catalysts, and appropriate additives and/or fillers.

Yet other advantages may become evident to those skilled in the art on reading the following examples, illustrated by the appended drawings, given by way of illustration and in no way limitative.

### BRIEF DESCRIPTION OF DRAWINGS

FIG. 1 is a graph showing the evolution of the temperature T measured (in 0° C.) as a function of the time t (in minutes) during the test of example 3. The temperature of the mould is indicated in bold line and that of the internal air of the mould in fine line.

FIG. 2 is a graph showing the loss modulus E″ (MPa) at 1.00 Hz as a function of the temperature in (° C.) during a DMTA (Dynamic Mechanical Thermal Analysis) test carried out on the bladder prepared in example 3.

FIG. 3 schematically represents one example of architecture of a type (IV) tank (1) manufactured from an envelope, bladder (2) obtained by the method according to the invention.

### EXAMPLES

### Example 1

### Example of Precursors to Prepare a Composition According to the Present Invention

The precursors used in the following examples to prepare polymerisation mixtures conforming to the present invention are as follows:
900 or 909 grade GYROTHANE® (registered trade name) precursor, manufactured by the RAIGI Company (supplier), mainly consisting of polyether polyols of polyoxypropylene glycol type, aromatic amines (chain modifier), additives (zeolite), carbon blacks and metal type catalyst.
FPG grade RAIGIDUR® (registered trade name) precursor, manufactured by RAIGI (supplier), consisting of an MDI based prepolymer type isocyanate.

### Example 2

### Example of a Device to Carry Out the Method of the Invention

The mixing of the reagents may be carried out manually or advantageously with an injection machine. The latter has two tanks, preferably thermostatted, for each of the precursors, a mechanical agitator integrated in each of the tanks and a metering pump for each of the tanks. The mixing is carried out either in a dynamic mixing head or in a static mixer (disposable or not), at the head outlet. Such an apparatus makes it possible to form polymerisation mixtures with higher quantities of precursors, having a better homogeneity, a better reproducibility and a better precision. Finally, the mixing time is much shorter (several seconds) than when the mixing of precursors is carried out manually. For example, a TWINFLOW SVR type injection machine, commercialised by the LIQUID CONTROL Company may be used.

The polymerisation mixture may be directly injected into the rotomould.

The rotomoulding apparatus used in these examples is of shuttle type, of STP Equipment make and reference LAB40, the heating of the rotomould oven is for its part electrical.

Before the injection of the polymerisation mixture, metal inserts such as base plates may be fixed in the rotomould, in the manner described in document [41], after having optionally been subjected to a surface treatment as described in document [6].

The injection of the mixture may be carried out via the opening in the base plate by using if necessary a cannula to facilitate the introduction.

### Example 3

### Formation of an Envelope (Bladder) and Tests on the Composition of the Invention

The reagents used in this example are those described in example 1. The composition used is as follows, expressed in % by weight: 39% by weight of 909 grade GYROTHANE® trade name polyol precursors and 61% by weight of FPG grade RAIGIDUR® trade name isocyanate precursors. In this example, the total quantity of material used is 600 g. The volume of the envelope is around 6 L for a thickness of 3 mm. The mixing is carried out by a TWINFLOW SVR trade name machine and commercialised by the LIQUID CONTROL Company. The polyol and the catalyst are introduced into a tank made of stainless steel and the isocyanate into the other. These tanks are each connected by a metering pump that delivers the correct quantity of each of the precursors then mixes them by means of a multi-element static mixer. This apparatus therefore makes it possible to form the polymerisation mixture and to introduce the determined quantity of material in 5 seconds directly inside the rotomould. The aluminium rotomould of 8 mm thickness is preheated to a temperature of 40° C.

Once the introduction of material has finished, the mould is made to rotate at a primary axis speed of 9 rpm and secondary axis speed of 3 rpm. The ratio of rotation speeds (primary/secondary ratio) is equal to 3.

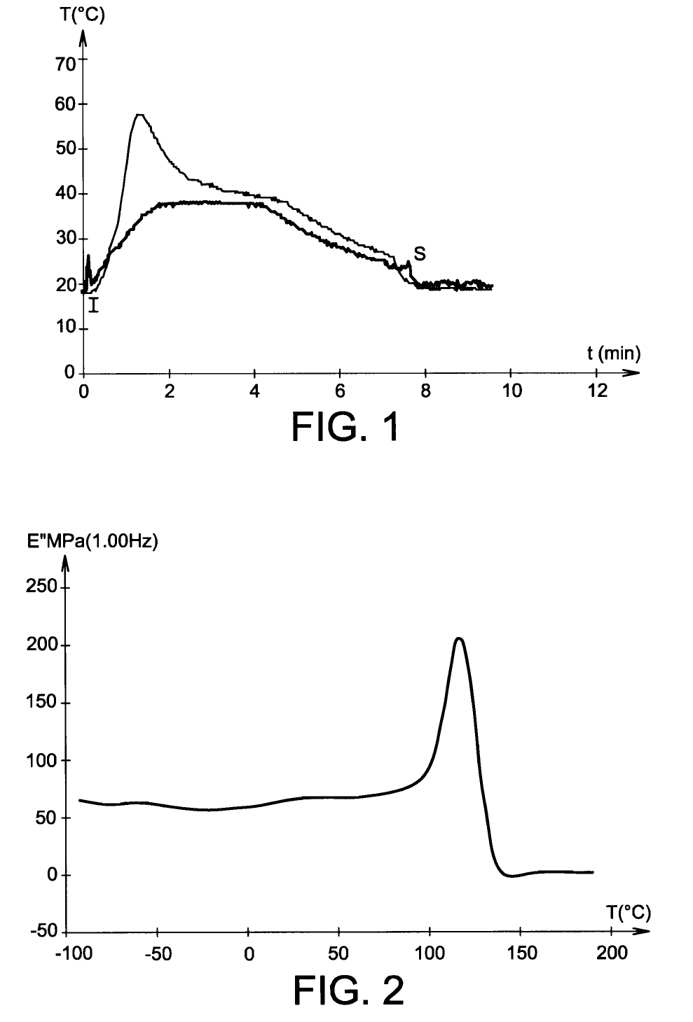

FIG. 1 summarises the temperature measurements carried out during this test.

The temperature of the mould is indicated in bold line and that of the internal air in thin line. The introduction of the material is marked by point I, point S indicating the mould being taken out of the oven for removal from the mould. The surpassing of the temperature curve of the mould by that of the internal air is due to the exothermic nature of the polymerisation reaction.

On the basis of these curves, the method used for this example may be described in the following manner:

1. Heating of the empty mould. This step is optional and more rapid than in the molten route given the fact that the mould is empty and that the temperatures are low.

2. Taking the mould out of the oven and stopping the rotation of the mould.

3. Introducing the polymerisation mixture in the mould, characterised by a drop in temperature of the mould, the introduced material being colder.

4. Rotating the mould and placing the mould inside the oven.

5. Cross-linking, characterised by an exotherm.

6. Taking the mould out of the oven, stopping the rotation and removal from the mould. Cooling is not necessary given the temperature employed.

The envelope thereby formed is neither oxidised, nor degraded; the polymer has not undergone chain breaks and does not have any unmelted material or residual porosities. Tests showing the physical properties of these parts are described hereafter (example 4).

### Example 4

### Properties of the Envelope, Bladder Made of Polyurethane Obtained in Example 3

### A. Tensile Mechanical Behaviour of the Polyurethane Part Obtained in Example 3

Tensile tests were carried out according to the ISO 527 Standard on H2 type dumbbell shaped test pieces (useful length 25 mm) at a crosspiece speed of 25 mm/min. The results are shown in Table 2 below.

TABLE 2
Characterisation of the tensile properties

| Test | Modulus of | Deformation | |
|---|---|---|---|
| temperature | elasticity | at break | Max. Stress (MPa) |
| (° C.) | (MPa) | (%) εr | σmax |
| 22° C. | 1800 MPa | 17% | 76 MPa |

The polyurethane sealing bladder obtained is sufficiently rigid to enable the winding of carbon fibres of the composite by filament winding. The mechanical deformation (ductility) of the polyurethane sealing bladder obtained is sufficient to enable a good cycling of the tank during phases of filling/emptying of the gas.

### B. Dynamic Mechanical Thermal Analysis (DMTA)

A DMTA test was performed on a sample taken from the sealing bladder obtained.

Dynamic mechanical thermal analysis (DMTA) makes it possible to determine the mechanical properties of a polymer sample subjected to a given cyclic loading, at fixed or variable temperature. The test machine used was of NIETZCH make and model DMA 242. The loss modulus E″ was measured at 5° K/min, and 1 Hz.

The curve of E″ (see FIG. 2) shows that there is no modification of the mechanical properties of the polymer of the bladder between −50° C. and 100° C.

The value given in the graph is not surprising: unlike a thermoplastic polymer, the polymer used according to the invention is not going to liquefy but will lose its modulus, while remaining intrinsically the same material.

The modulus known as the “loss modulus” is proportional to the energy dissipated by the irreversible deformation of the material. The increase in the loss modulus is significative of the passage of transition from one state to another such as for example the glass transition.

In FIG. 2, beyond the glass transition temperature (120° C.) the material gains flexibility but does not liquefy. This transition is reversible.

### C. Gaseous Hydrogen Barrier Performance

Hydrogen permeation measurements were carried out on disk shaped samples of 2 mm thickness and 30 mm diameter and at 25° C. and under a relative pressure of 50 bars. The results obtained (cf. Table 3) show that the sealing envelope has good hydrogen barrier properties and that its use as type IV tank bladder is possible for service pressures of 350 and 700 bars (35 and 70 MPa).

TABLE 3
Hydrogen permeation properties (pressure of
50.45 bars and temperature of 26.7° C.)

| | Time to attain a | Permeation | |
|---|---|---|---|
| Flux | stationary regime | coefficient Pe | Diffusion coefficient |
| (mbar · l/s) | (hours) | (mol/m · Pa · s) | D (m²/s) |
| 1.10⁵ | 35.3 | 6.8 10⁻¹⁶ | 8.1 10⁻¹¹ |

### Example 5

### Formation of an Envelope According to the Method of the Invention

The reagents used in this example are those described in example 1. The composition used is as follows, expressed in % by weight: 31.4% of 909 grade GIROTHANE®, 7.8% of 900 grade GIROTHANE® and 60.8% of FPG grade RAIGIDUR®. In this example, the total quantity of material used is 5676 g. The volume of the envelope is around 80 L for a thickness of 4 mm. The mixing is carried out manually or ideally by a TWINFLOW SVR machine of LIQUID CONTROL. The polyol precursors are introduced into one of the two tanks made of stainless steel and the precursor isocyanate into the other. These tanks are each connected to a metering pump that assures the ratio of the compounds and forces them to pass through a multi-element static mixer. This apparatus therefore makes it possible to carry out the mixing and to introduce the determined quantity of material in 30 seconds directly inside the rotomould previously coated with mould release agent and stabilised at room temperature or locally preheated to a temperature of 40° C.

Once the introduction of material has been completed, the mould is rotated at a primary axis rate of 7.2 rpm and a secondary axis rate of 1.5 rpm. The mould is made of 3 mm thick steel. The ratio of the rotation rates (primary/secondary ratio) is equal to 4.8. When the material is at 20° C. and itself introduced into the rotomould at 20° C., the normal exotherm of the reaction leads to an additional rise of 30 to 40° C. in around 5 minutes. The part is kept rotating for 15 minutes before removing it from the mould. The mould removal step may if necessary be preceded by 5 minutes of cooling obtained, for example, by a forced ventilation, to improve the stiffness of the part on removal from the mould.

The part obtained has a rugby ball shape with an inter-pole length of 1400 mm, a maximum diameter of 400 mm and an internal volume of 80 L.

### Example 6

### Manufacture of a Type IV Tank

The manufactured tank (1) is represented in the appended figure. In this example, the envelope (E) manufactured in example 3, provided with its base plate (4), is provided with a reinforcement structure (6). To do this, carbon fibres previously impregnated with non cross-linked epoxy resin are wound round the envelope maintained by the base plate (the bladder serves as mandrel) according to one of the methods described in documents [4], [5], [24] or [25].

Several layers of glass fibres impregnated with non cross-linked epoxy resin are then wound round as for the carbon fibres. The wound tank is then placed in a revolving oven to harden the epoxy resin.

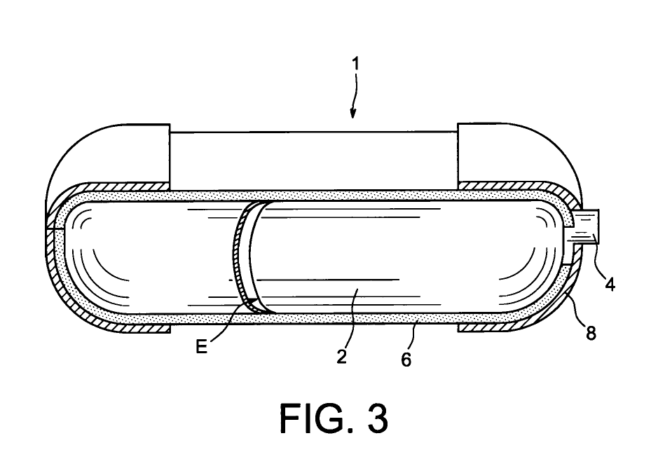

A protective shell (8) may then be arranged around the filament winding as represented in cross section in FIG. 3. A valve/pressure regulator may be screwed onto the tank, in the base plate (not represented).

A type IV tank is thereby obtained. This tank has the abovementioned sealing specifications.

### Example 7

### Post-Treatment of a Bladder Obtained According to the Method of the Invention

An envelope manufactured according to the method of the present invention, for example according to the protocol of example 2, may be subjected to a post-treatment such as those cited in the description part of the invention here above, in order to improve its sealing properties as well as its internal and/or external surface chemical properties.

Examples of post-treatments applicable to the bladder are described in documents [26] and [27] in the appended list of references.

### LIST OF REFERENCES

[1] FR-A-2 871 091: “Procédé de fabrication d'une vessie d'étanchéité d'un réservoir de type IV et reservoir de type IV”
[3] FR-A-2 813 232: “Procédé de fabrication d'une pièce de révolution par rotomoulage et pièce obtenue”
[4] FR-A-2 813 235: “Structure et réservoir thermoplastique”
[5] U.S. Pat. No. 4,927,038: “Container for high pressure gases”
[6] U.S. Pat. No. 4,925,044: “Fluid tank and method of manufacturing it”
[7] U.S. Pat. No. 5,499,739: “Thermoplastic liner for and method of overwrapping high pressure vessels”
[8] U.S. Pat. No. 6,554,939: “Container and method of forming the container”
[9] U.S. Pat. No. 5,568,878: “Filament wound pressure vessel having a reinforced access opening”
[10] U.S. Pat. No. 6,660,214: “Pressure vessel manufacture method”
[11] U.S. Pat. No. 6,298,553: “Composite pressure vessel with heat exchanger”
[12] Patent Abstract of Japan, vol. 1995, n°10 “Manufacture of pressure vessel”
[13] U.S. Pat. No. 4,705,468: “Apparatus for rotationally casting a plastic tank liner having an access fitting”
[14] WO-A2-03/069217: “Twin-walled liner for high-pressure vessels”
[15] U.S. Pat. No. 5,647,503: “Tank for storing pressurized gas”
[16] U.S. Pat. No. 6,090,465: “Reinforced composite structures”
[17] U.S. Pat. No. 4,932,403: “Flexible container for compressed gases”
[18] U.S. Pat. No. 5,036,845: “Flexible container for compressed gases”
[19] U.S. Pat. No. 6,651,659: “Ambulatory storage system for pressurized gases”
[20] U.S. Pat. No. 6,866,042: “Conserver for pressurized tank”
[21] “Hydrogen Storage Gaps and Priorities. Hydrogen Implementing Agreement”, Trygve RIIS, oral communication, IAE Hydrogen Coordination Group, Paris, Nov. 29, 2004
[22] “Next generation hydrogen tankage”, Laurence Livermore National Laboratory, proceedings of the 2001 U.S. DOE Hydrogen Program Review
[23] “Hydrogen composite tank program”, Quantum Technologies, proceedings of the 2002 U.S. DOE Hydrogen Program Review
[24] “Hydrogen composite tank project”, Quantum Fuel System Technologies, FY 2003, Progress Report
[25] “Development of a Compressed Hydrogen Gas Integrated Storage System (CH₂-ISS) for Fuel Cell Vehicles”, University Applied Physics Laboratory, FY 2003 Progress Report.
[26] “Next Generation Hydrogen Storage”, Laurence Livermore National Laboratory, FY 2003 Progress Report
[27] “Low Permeation Liner for Hydrogen Gas Storage Tanks”, Idaho National Engineering & Environmental Laboratory, FY 2003 Progress Report
[28] “Low cost, high efficiency, high pressure hydrogen storage”, Quantum Technologies Inc., DOE Hydrogen Fuel Cells & Infrastructures Technologies Program Review, May 2004
[29] “The hydrogen fuel cells and infrastructure technologies (HFCCIT) program multi-year program plan”, U.S. Department of Energy, May 1, 2003
[30] “Development and validation testing of hydrogen fast-fill fueling algorithms”, Williams E. LISS, Mark E. RICHARDS, Kenneth KOUNTZ, Kenneth KRIHA, Gas Technology Institute, USA
[31] “Modeling and testing of fast-fill control algorithms for hydrogen fueling”, 2003 National Hydrogen Association Meeting, March 2003
[32] “Application of plastic-lined composite pressure vessels for hydrogen storage”, John A. EIHUSEN, Lincoln, USA
[33] “Fast fill test of 35 MPa hydrogen for high pressure cylinder” Kiyotaka KAKIHARA, Koichi OSHINO, Jinji SUZUKI, Shogo WATANABE, JARI Research Journal, vol. 26, N°6
[34] “Thermal effects related to H2 fast filling in high pressure vessels depending on vessels types and filling procedures: modelling, trials and studies”, K. BARRAL, E. WERLEN, R. RENAULT, Proceedings of the European Hydrogen Energy Conference, September 2003, Grenoble, France
[35] “Hydrogen refuelling stations: safe filling procedures”, J-Y. FAUDOU, J-Y LEHMAN, S. PREGASSAME, AIR LIQUIDE
[36] http://www.rotomoulage.org
[37] “Etude de la nature de couches barrières à l'oxygène réalisées par plasma basse fréquence en fonction des conditions d'élaboration”, Eric Bouvier, Université Paul Sabatier de Toulouse, thesis defended on the Sep. 14, 1999 order number 3457
[38] “Trends in Barrier Design”, May 1991, Journal Packaging, Japan
[39] U.S. Pat. No. 6,328,805: “Equipment for processing using a low-pressure plasma having an improved vacuum circuit”
[40] U.S. Pat. No. 5,902,643: “Multilayer packaging material having aminoepoxy gas barrier coating”.
[41] U.S. Pat. No. 5,538,680: “Method of molding a polar boss to a composite pressure vessel”
[42] U.S. Pat. No. 6,171,423: “Method for fabricating composite pressure vessels”
[43] U.S. Pat. No. 5,577,630: “Composite conformable pressure vessel”

1. Method for manufacturing a polymer bladder assuring the internal sealing of a tank vis-à-vis a pressurized fluid which is contained therein, wherein said fluid is under a pressure of at least 50 bars, preferably at least 200 bars, even more preferably at least 350 bars, most preferably at least 700 bars; wherein said polymer is a thermosetting polymer, and said method comprises at least one step of polymerising at least two precursor compounds of said thermosetting polymer carried out in a mould in rotation.

2. Method according to claim 1, in which the polymer bladder is self-supporting.

3. Method according to claim 1, in which the bladder is of cylindrical shape with hemispheric bottoms.

4. Method according to any one of the preceding claims, in which the polymerisation of the thermosetting polymer in the mould in rotation is initiated at a temperature from 10 to 100° C.

5. Method according to any one of the preceding claims, in which the bladder is manufactured in a time from 4 to 8 minutes.

6. Method according to any one of the preceding claims, in which said tank is a composite tank.

7. Method according to claim 6, in which the tank is a type IV tank.

8. Method according to any one of the preceding claims, in which the fluid is a gas or a mixture of a gas and a liquid.

9. Method for manufacturing a polymer bladder according to any of the preceding claims, said method comprising the following successive steps:
(a) preparation of a polymerisation mixture comprising the precursor compounds of the thermosetting polymer, and optionally at least one polymerisation catalyst;
(b) polymerisation of said mixture to obtain said thermosetting polymer in a mould in rotation, so as to form said bladder by polymerisation of said precursors and simultaneous rotomoulding of the thermosetting polymer;
(b1) optionally repetition of steps (a) and (b) so as to obtain a bladder with several layers of thermosetting polymer; and
(c) removal from the mould of the thermosetting polymer bladder obtained.

10. Method according to claim 9, in which the polymerisation of the thermosetting polymer in the mould in rotation is initiated at a temperature from 10 to 100° C., for example 40° C.

11. Method according to any one of claims 9 and 10, in which, prior to step (b), the temperature of the polymerisation mixture is regulated to a value of 10 to 100° C. for example 25° C.

12. Method according to any one of claims 9 to 11, in which the temperature of the mould is regulated, for example by heating, totally or partially, prior to step (b) to a value of 10 to 120° C., for example 40° C.

13. Method according to any one of claims 9 to 12, in which the mould has the shape of a hollow revolving part.

14. Method according to claim 13, in which said mould has a substantially cylindrical shape, with a length/diameter ratio of 1 to 50, normally from 2 to 10.

15. Method according to any one of claims 9 to 14, in which the mould is rotated along two axes, so that the distribution of said polymerisation mixture takes place over the whole internal surface of the mould and in conformity with it.

16. Method according to any one of claims 9 to 15, in which the polymerisation mixture further comprises one or several fillers and/or nanofillers.

17. Method according to claim 16, in which the fillers and/or the nanofillers are chosen among clay flakes, foils, carbon blacks, carbon nanotubes, silicas, carbonates, kaolins, dolomites, other mineral fillers, pigments, zeolites and organic fillers.

18. Method according to any one of claims 9 to 17, in which the polymerisation mixture further comprises one or several additives chosen among antioxidants, stabilisers, plastifiers, wetting agents, debubblizing agents, fire retarding agents, colorants and liquid solvents.

19. Method according to any one of claims 9 to 18, in which the polymerisation mixture further comprises a chain modifier.

20. Method according to any one of the preceding claims, in which the thermosetting polymer is a polyurethane.

21. Method according to claim 20, in which the precursors comprise at least one polyol and at least one isocyanate.

22. Method according to any one of claims 9 to 21, in which the mixture is prepared from several premixtures each containing at least one precursor of the polymer.

23. Method according to claim 22, in which the mixture is prepared from two premixtures, one of the premixtures (A) containing one or several polyol(s), optionally one (or several) catalyst(s), one or several filler(s) and one or several additive(s); and the other premixture (B) containing one or several isocyanates and optionally one or several additives.

24. Method according to claim 23, in which the other premixture (B) contains a prepolymer with isocyanate terminations.

25. Method according to claim 22, in which one of the premixtures (A) contains one or several polyol(s) and if necessary one or several chain modifiers.

26. Method according to claim 9, in which a cycle of steps (a) and (b) is repeated to form a sealing bladder with several layers of polymers, identical or different in thickness and/or in composition.

27. Method according to claim 26, in which step (a) of a cycle is begun before step (b) of a previous cycle has completely finished.

28. Method according to any one of claims 9 to 27, in which at least one tank base plate is fixed to the inside of the mould before implementing step (b) so that the tank base plate is incorporated in the bladder during the polymerisation.

29. Pressurized fluid storage tank (1), said tank comprising an internal envelope or sealing bladder made of polymer (2) obtainable by the method according to any one of claims 1 to 28.

30. Tank according to claim 29 which is a composite tank.

31. Composite tank according to claim 30, said tank comprising in this order, from the interior of the tank towards its exterior, at least:
said internal sealing envelope or bladder (2),
at least one base plate (4), and
a mechanical reinforcement (6) external to the envelope.

32. Composite tank according to claim 31, in which said sealing bladder is a bladder made of polyurethane.

33. Composite tank according to any one of claims 31 and 32, in which said at least one base plate is a metallic base plate.

34. Composite tank according to any one of claims 31 to 33, in which said external mechanical reinforcement is a filament winding consisting for example of carbon fibres and thermoplastic or thermosetting resin for example epoxy resin.

35. Tank according to any one of claims 29 to 34, in which the fluid is a pressurized gas.

36. Tank according to claim 35, in which the pressurized gas is chosen among inert gases such as helium and argon, air, nitrogen, hydrogen, natural gas, hydrocarbons such as methane, and mixtures thereof such as argonite and hytane.

37. Tank according to any one of claims 29 to 36, wherein the envelope has a thickness such that it enables a service pressure of the tank between 10⁷ and 10⁸ Pa, preferably from 5.10⁷ to 8.10⁷ Pa.

38. Tank according to any one of claims 29 to 37, wherein said tank is a type IV tank.

39. Tank according to any one of claims 29 to 38, in which said bladder is self-supporting.

40. Tank according to any one of claims 29 to 39, in which said bladder is of cylindrical shape with hemispheric bottoms.
